(19) United States
(12) Patent Application Publication
(10) Pub. No.: US 2005/0200333 A1
(43) Pub. Date: Sep. 15, 2005

(54) Vehicle accessory voltage generator and battery power savings device

(76) Inventor: Gerald Khau, Cerritos, CA (US)

Correspondence Address: VENABLE LLP, P.O. BOX 34385, WASHINGTON, DC, 20045-9998, US

(21) Appl. No.: 10/795,518

(22) Filed: Mar. 9, 2004

(51) Int. Cl. H02J 7/00

(52) U.S. Cl. 320/132

(57) ABSTRACT

A method of generating a vehicle accessory voltage (ACC) signal when an ignition switch is turned on in an area where the ignition voltage (IGN) line is not available. The method can automatically turn off a source of power for devices such as, e.g., audio, video or other mobile devices at completion of a preset time on a timer to save battery power.

### BACKGROUND OF THE INVENTION

1. Field of the Invention

The present invention relates generally to custom electronic device installation and more particularly to custom device installations in vehicles.

2. Related Art

Conventionally, when an ignition switch is turned on in a vehicle, the ignition switch connects an ignition voltage line (IGN) to a power storage source, such as, e.g., a +12 volt vehicle battery. The power storage source may provide power for electronic devices such as, e.g., a radio, a display panel light, power windows, etc. Vehicles include, e.g., but not limited to, cars, planes, trains, buses, boats, etc.

Conventionally, many vehicles may include, e.g., an audio/video (A/V) mobile entertainment system that may be installed at a factory, or using after market parts and service providers. Many vehicles may include, e.g., an A/V system including, e.g., a video monitor, a digital versatile disc (DVD) player, a video cassette recorder (VCR), a television (TV) tuner, and/or a video game console. Many of these electronic devices may require a connection to the vehicle battery, the IGN, and ground. Unfortunately, the IGN line may not always be available in all convenient locations for installation of such devices. For example, some areas which may be ideal for mounting an A/V device such as, e.g., at a location of an overhead dome light, a headrest and in a trunk of a vehicle, may only have a battery wire and ground, and do not have the IGN available. To run the IGN from the ignition switch to the overhead dome light's location, or to the trunk may not only require an extended amount of time and associated service cost and parts, but in some cases, doing so may not be practical, or may cause damage to the vehicle's interior upholstery.

Since most A/V devices connect to the battery and IGN, when the vehicle is inoperative or the ignition switch is turned off, although there may be no IGN, the A/V devices may still be connected to the battery. Although the devices may not be operating, or may be in a standby or off mode, the devices may still draw current from the battery. Over a period of time, the energy drawn from these A/V devices may reduce the state of charge of the battery below a minimum threshold level required for starting the vehicle. Many existing mobile A/V products on the market may draw excessive standby current. It may only take 5 to 10 days for an inoperative vehicle battery to be drained.

Many owners of a vehicle may have experienced a dead battery in a vehicle because the owner left a door, trunk or hood open unintentionally for a period of time. Over a period of time, energy drawn from a dome light, trunk light or hood light may reduce the state of charge of the battery to below a minimum threshold level required for starting the vehicle.

### SUMMARY OF THE INVENTION

The present invention may include, in an exemplary embodiment, a system, method and/or computer program product, directed to overcoming one or more of the problems set forth above.

Briefly summarized, according to one exemplary embodiment of the present invention, an installer may mount, e.g., an overhead video display, or other device, in a dome light area and/or may install a DVD and/or VCR in an automobile trunk where only a battery and ground wire may be conventionally available. According to the exemplary embodiment of the present invention, an accessory voltage (ACC) may be generated that may simulate to the IGN to turn the respective devices on or off when the ignition switch is turned on and off, respectively.

Another exemplary embodiment of the present invention may include a power saver timer circuit. The power saver timing circuit may hold power for a given period of time such as, e.g., 5 hours for a DVD player, so that, e.g., the DVD player does not lose memory of where a video being watched has been paused, during a brief break during a trip and may ensure resumption of the DVD where the view left off before the break. However, the power saver timing circuit may be adapted to cut power to the DVD player at the completion of the exemplary 5 hours period from when the ignition switch was first turned off. The timed cutoff ensures that the battery will not drain from the continual draw from the device. Thus, energy may be always available from the battery, to start the vehicle. For example, the timer may be programmed to allow for resumption from a few seconds break, a few minutes break, to a few hours break, or a few days.

In another exemplary embodiment, the state of the battery may be determined, via, e.g., monitoring, and the length of time of the timer may be varied in accordance with an estimated capacity for the battery to be able to maintain sufficient energy to allow successful starting of the ignition.

These and other aspects, features and advantages of the present invention will be more clearly understood and appreciated from a review of the following detailed description of the exemplary preferred embodiments and appended claims, and by reference to the accompanying drawings.

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a basic vehicle including a voltage source, a battery, and an ignition, according to an exemplary embodiment of the present invention;

FIG. 2 depicts an exemplary embodiment of a diagram illustrating an exemplary vehicle voltage change from 12V to 13V according to an exemplary embodiment of the present invention;

FIG. 3 depicts an exemplary embodiment of an accessory voltage generator according to an exemplary embodiment of the present invention;

FIG. 4 depicts an exemplary embodiment of a battery power saver according to an exemplary embodiment of the present invention; and

FIG. 5 depicts an exemplary embodiment of an accessory voltage generator and batter power saver according to an exemplary embodiment of the present invention.

### DETAILED DESCRIPTION OF EXEMPLARY EMBODIMENTS OF THE PRESENT INVENTION

A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

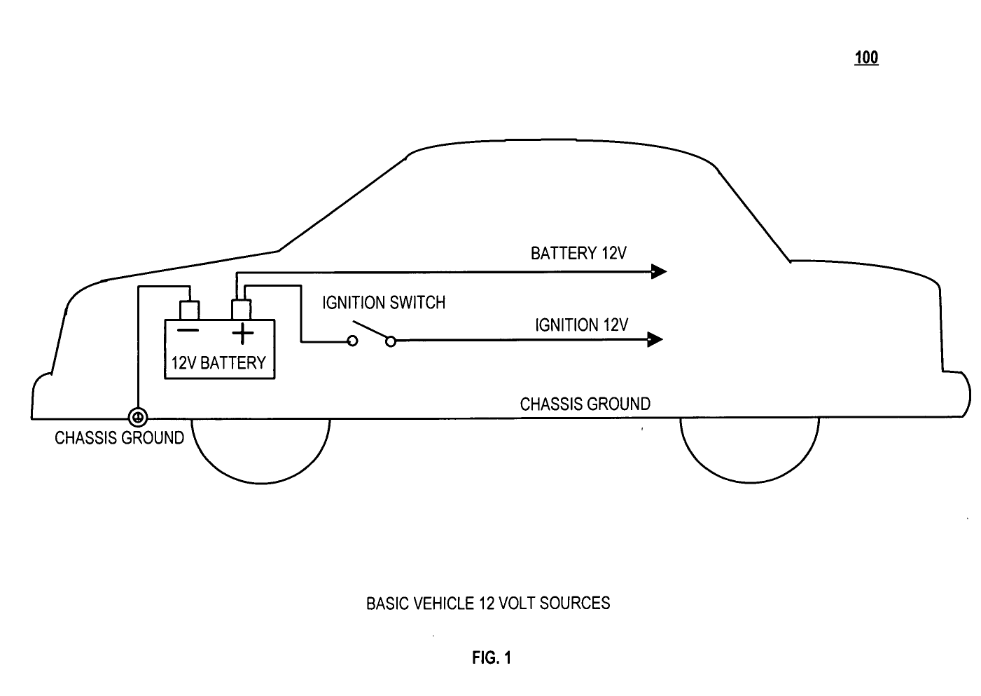

FIG. 1 depicts an exemplary embodiment of a basic wiring diagram 100 of an exemplary battery voltage and ignition voltage in an exemplary vehicle according to an exemplary embodiment of the present invention.

When a vehicle engine is not running, most vehicle batteries measure from approximately 12.0V to 12.4V. Simplifying, we may call a vehicle voltage level 12V, or hereafter, battery voltage Vb.

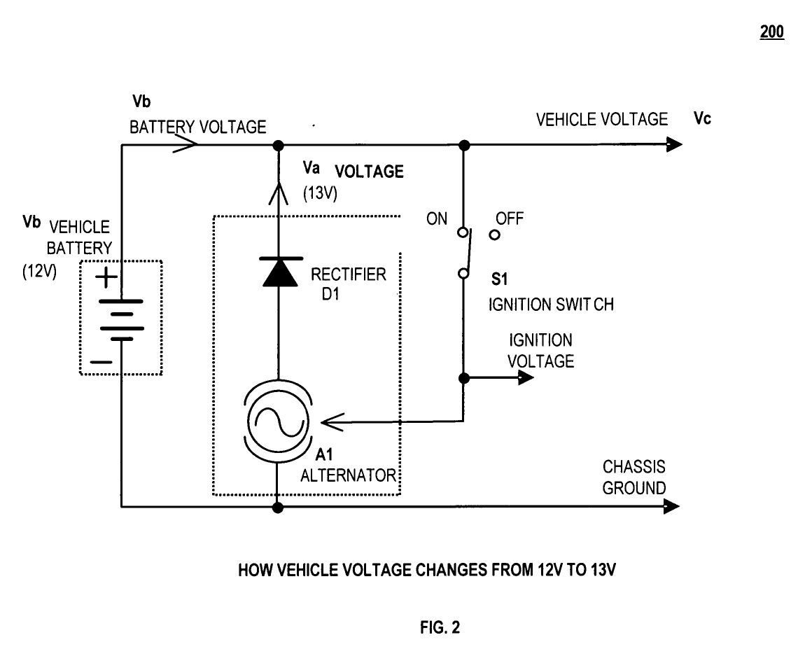

As shown in diagram 200 of FIG. 2, in an exemplary embodiment of the present invention, when an ignition switch S1 is initially in an off position, an exemplary vehicle voltage, referred to as Vc, may be obtained from the battery voltage Vb, i.e., 12 Volts, of the vehicle. When the ignition switch S1 is switched to an on position, as shown, the vehicle engine may begin to run, alternator A1 may generate alternating current (AC), this AC current may be rectified by a rectifier D1 and may thereby become a direct current (DC). The new voltage source may be higher than the initial battery voltage Vb. The new voltage may be conventionally measured to be approximately 13.8V or sometimes higher. To simplify the analysis, we may call it a 13V, hereafter, new voltage source Va. The vehicle voltage Vc while the engine is running is generally obtained from the new voltage source Va, equal to approximately 13 Volts.

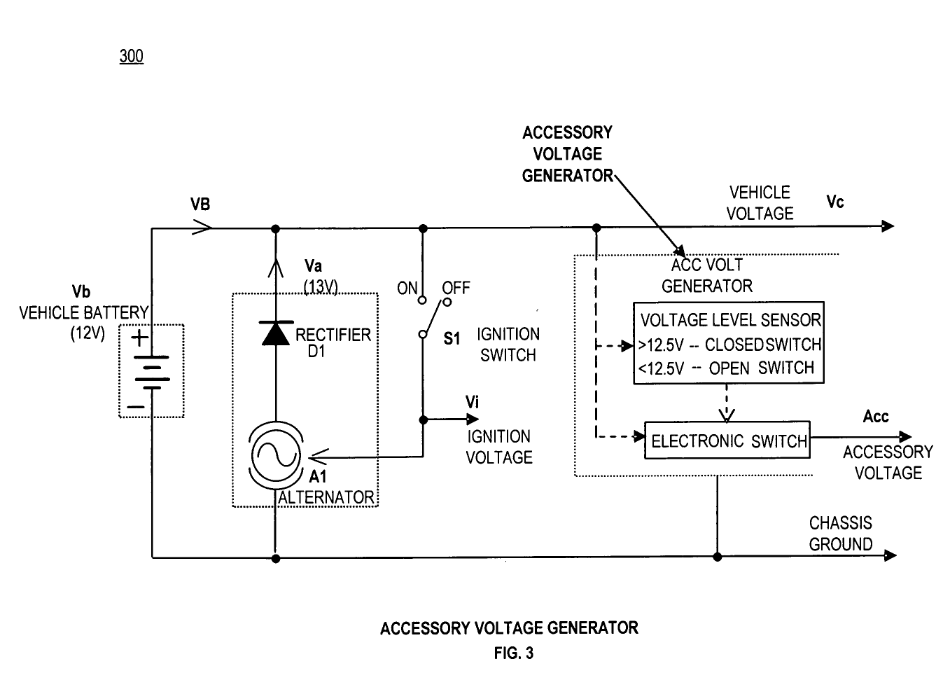

Referring now to diagram 300 in FIG. 3, an exemplary embodiment of an accessory voltage generator according to the present invention is illustrated, including a voltage level sensor and an electronic switch, in an exemplary embodiment. The voltage level sensor circuit may monitor a state of charge of the vehicle battery and may detect when the state of charge of the battery changes from 12V to 13V or vice-versa. For instance, the voltage level sensor circuit may monitor the voltage if it passes the 12.5V threshold level, and in response may send out a command signals to that effect.

When S1 is in an off position, Vc may equal 12 Volts. The voltage sensor circuit according to an exemplary embodiment may sense the voltage level (which may be less than 12.5V) and may turn the electronic switch of the accessory voltage generator to an off position. Thus, the accessory voltage (Acc) may as a result be off and may equal 0 Volts, i.e., the same as the ignition voltage Vi.

When S1 is in an on position, Vc may equal 13 Volts. The voltage sensor circuit according to an exemplary embodiment may sense the 13V level (which is higher than 12.5V) and may in response turn the electronic switch to an on position. The Acc may as a result be on and may equal 13 Volts, i.e., the same as the ignition voltage Vi.

Thus, another source of voltage Acc may be provided, behaving the same as ignition voltage Vi, and producing similar outputs.

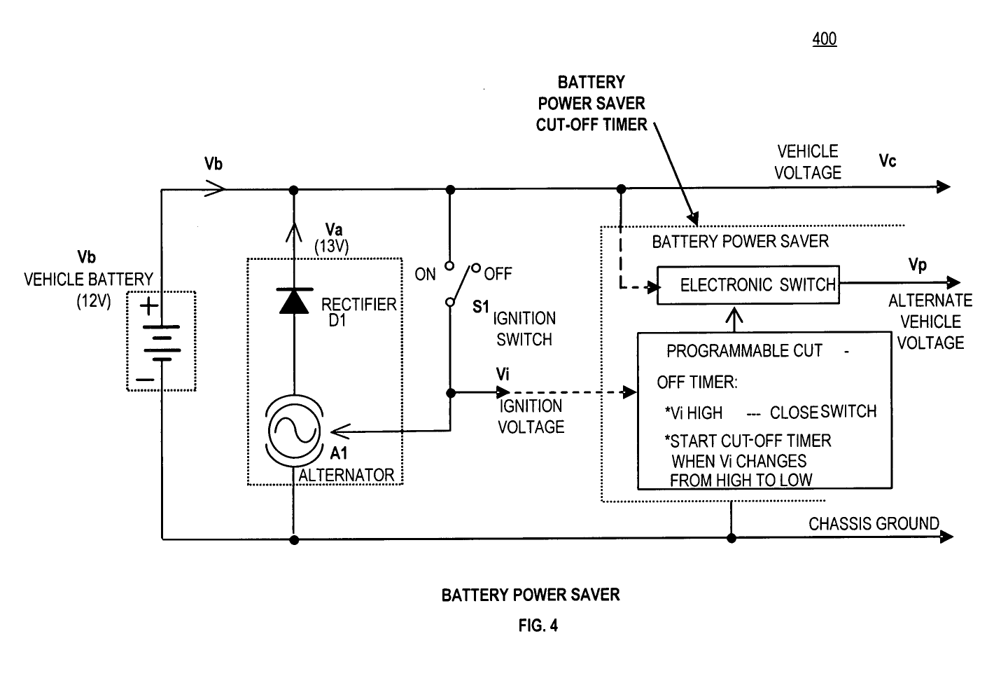

Referring to diagram 400 of FIG. 4, an exemplary embodiment of a battery power saver is illustrated including a programmable timer circuit, and an electronic switch. The programmable timer circuit may be triggered by the ignition voltage Vi. When S1 is on and Vi is high, the electronics switch may be closed and Vp may be coupled to Vc and may equal 13V.

When S1 is turned from on to off, Vi may change from high to low, the electronics switch may still be closed and the Vp may stay high and may equal 12V. However, the programmable timer circuit may begin to count down. Initially, in an exemplary embodiment, the electronics switch may remain closed until the counter reaches zero, and thereafter the electronic switch may open, and as a result, Vp may be off and may equal 0 Volts.

Thus, a new source of vehicle voltage that may cut-off automatically at a set time following the ignition switch being switched off. In an exemplary embodiment, the timer may be preset at a particular amount of time. In another exemplary embodiment, the time may be set using, e.g., inputs, such as, e.g., a hardware or software, jumper, or switch setting.

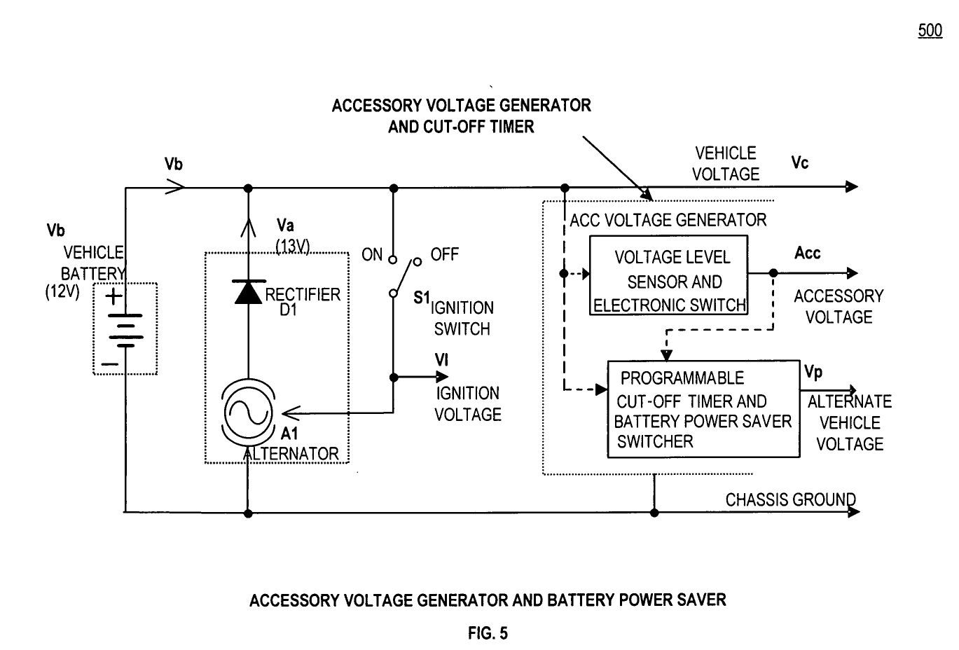

The accessory voltage generator and battery power saver may also be combined into a single device, in another exemplary embodiment, as shown in diagram 500 of FIG. 5. In the circuit of diagram 500, a newly generated Acc may be used as a trigger voltage for the timer circuit.

In this document, certain subsystems may be implemented as computer or processor systems. The terms “computer program medium” and “computer readable medium” may be used to generally refer to media such as, e.g., but not limited to a removable storage drive, a hard, floppy, or optical disk installed in a disk drive, and signals, etc. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform the data into other electronic data that may be stored in registers and/or memory. “Computing platforms” may include one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in a main memory and/or a secondary memory and/or removable storage units, also called computer program products. Such computer programs, when executed, may enable the computer system 500 to perform the features of the present invention as discussed herein. In particular, the computer programs, when executed, may enable a processor to provide a method to resolve conflicts during data synchronization according to an exemplary embodiment of the present invention. Accordingly, such computer programs may represent controllers of the computer system.

In another exemplary embodiment, the invention may be directed to a computer program product comprising a computer readable medium having control logic (computer software) stored therein. The control logic, when executed by the processor, may cause the processor to perform the functions of the invention as described herein. In another exemplary embodiment where the invention may be implemented using software, the software may be stored in a computer program product and loaded into computer system using, e.g., but not limited to, removable storage drive, hard drive or communications interface, etc. The control logic (software), when executed by the processor, may cause the processor to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s). In another exemplary embodiment, the invention may be implemented primarily in firmware.

In yet another exemplary embodiment, the invention may be implemented using a combination of any of, e.g., but not limited to, hardware, firmware, and software, etc. For example, a timer may be implemented in hardware, software, firmware, or some combination.

The exemplary embodiments of the present invention may be implemented using, a wireless communication link, such as, e.g., a wireless local area network (WLAN). For example, a WLAN may be used to communicate between subsystems of the vehicle, to provide, e.g., monitoring information, status information, indications of certain conditions such as, e.g., whether an ignition is on or off. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., IEEE Std 802.11, 1999 Edition; or IEEE Std 802.11a-1999, IEEE Std 802.11b-1999, IEEE Std 802.11b-1999/Cor 1-2001, IEEE Std 802.11d-2001, IEEE Std 802.11-1999 (R2003), and/or IEEE 802.11g-2003, etc.), etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method comprising:
monitoring a battery voltage of a vehicle including
determining when said vehicle is turned on;
generating an accessory voltage line (ACC) when an ignition switch is turned on, including
providing said ACC to one or more devices where an ignition voltage line (IGN) is not available.

2. The method of claim 1, further comprising the steps of:
allowing operating of said devices by the ACC when said ignition switch is determined to be on.

3. The method of claim 1, further comprising the steps of:
terminating operation of said devices when said ignition switch is determined to be off.

4. The method of claim 1, further comprising the steps of:
monitoring state of charge of said vehicle battery.

5. The method of claim 1, wherein said one or more devices comprises one or more selected from the group consisting of:
an audio device;
a video device;
an audio/video device;
an electronics device;
an optical device;
a navigation system; and
a rear seat device.

6. The method of claim 1, wherein said vehicle comprises one or more selected from the group consisting of:
a car;
a van;
a truck;
a plane;
a train;
a boat; and
another type of vehicle.

7. A method comprising:
removing power of a power storage source from a device of a vehicle upon expiration of a time period from time of shutoff of an ignition switch of said vehicle.

8. The method of claim 7, further comprising:
allowing said device to stay on in standby mode for a period of time after said ignition switch of said vehicle is turned off.

9. The method of claim 7, wherein the method comprises:
cutting off power from said device upon expiration of a preset timer stopping drainage of said power storage device.

10. The method of claim 7, wherein said power storage device comprises a battery.

11. The method of claim 7, further comprising the steps of:
using low current draw components to minimize power consumption of said device.

12. The method of claim 7, wherein said device comprises one or more devices selected from the group consisting of:
an audio device;
a video device;
an audio/video device;
an electronics device;
an optical device;
a navigation system; and
a rear seat device.

13. The method of claim 7, wherein said vehicle comprises one or more selected from the group consisting of:
a car;
a van;
a truck;
a plane;
a train;
a boat; and
another type of vehicle.

14. A system comprising:
a circuit adapted to monitor a battery voltage of a vehicle, to determine when said vehicle is turned on, to generate an accessory voltage line (ACC) when an ignition switch is turned on, and to provide said ACC to one or more devices where an ignition voltage line (IGN) is not available.

15. The system of claim 14, wherein said circuit is further adapted to allow operation of said device by the ACC when said ignition switch is determined to be on; and to terminate operation of said device when said ignition switch is determined to be off.

16. The system of claim 14, wherein said circuit is further adapted to monitor a state of charge of said vehicle battery.

17. The system of claim 14, wherein said one or more devices comprise one or more selected from the group consisting of:
an audio device;
a video device;
an audio/video device;
an electronics device;
an optical device;
a navigation system; and
a rear seat device.

18. The system of claim 14, wherein said vehicle comprises one or more selected from the group consisting of:
a car;
a van;
a truck;
a plane;
a train;
a boat; and
another type of vehicle.

19. The system of claim 14, wherein said circuit is further adapted to terminate operation of said device following conclusion of a set time period, said time period beginning from a time when said ignition switch is determined to be off.
